(19) United States
(12) Patent Application Publication
(10) Pub. No.: US 2026/0332252 A1
(43) Pub. Date: Oct. 22, 2026

(54) SELF-HEALING METHOD AND DEVICE FOR NODE FAILURES IN ONOC

(71) Applicant: Beijing University of Posts and Telecommunications, Beijing (CN)

(72) Inventors: Qiuyan YAO, Beijing (CN); Hui YANG, Beijing (CN); Chen ZHAO, Beijing (CN); Daqing MENG, Beijing (CN); Jie ZHANG, Beijing (CN)

(73) Assignee: Beijing University of Posts and Telecommunications, Beijing (CN)

(21) Appl. No.: 19/275,561

(22) Filed: Jul. 21, 2025

(30) Foreign Application Priority Data
Apr. 21, 2025 (CN) 202510501575.X

(51) Int. Cl. H04B 10/03

(52) U.S. Cl. CPC H04B 10/03

(57) ABSTRACT

A self-healing method for node failures in an ONoC includes: identifying a failed node in the ONoC; determining a self-healing strategy based on a topology of the ONoC; and resetting nodes in the ONoC according to the self-healing strategy. Further, a self-healing device for node failures in an ONoC, an electronic device and a non-transitory computer-readable storage medium related to the self-healing method for node failures in an ONoC are also disclosed.

### CROSS-REFERENCE TO RELATED APPLICATIONS

This application claims priority to Chinese Patent Application No. 202510501575.X, filed on Apr. 21, 2025, the content of which is incorporated herein by reference in its entirety.

### TECHNICAL FIELD

The present disclosure relates to optical communications, and in particularly, to a self-healing method and a device for node failures in an Optical Network-on-Chip (ONoC).

### BACKGROUND

With a rapid advancement of integrated circuit technologies, the number of transistors integrated on a chip has experienced an explosive growth driven by the Moore's Law. This has led to a dramatic increase in intra-chip data transmission demands. Traditional on-chip bus architectures, constrained by bandwidth bottlenecks and high power consumption drawbacks, struggle to meet escalating communication requirements. Against this backdrop, photonic technology has emerged as a key solution to overcome intra-chip communication challenges, leveraging its high bandwidth, low latency, and exceptional electromagnetic interference immunity. An Optical Network-on-Chip (ONoC) have thus arisen as a solution. By utilizing optical signals for data transmissions, the ONoC may establish a novel paradigm for intra-chip communications, enabling a long-distance and a high-speed data transmission within a single-package system while transmission latencies and power consumptions can be significantly reduced. ONoCs are progressively becoming a focal industry research area, with their development holding critical significance for addressing future complex multi-core system design challenges.

Consequently, there is a critical need to develop a self-healing method of a network topology in an ONoC applicable in diverse topological structures, supporting rapid self-healing capabilities, and enabling effective dynamic response with adaptive reconfiguration facing node failures.

### SUMMARY

In view of the above, examples of the present disclosure provide a self-healing method and a device for node failures in an ONoC, capable of enabling effective dynamic responses and adaptive reconfigurations of the network topology when node failures occur in an ONoC.

The self-healing method for node failures in an ONoC may include: identifying a failed node in the ONoC; determining a self-healing strategy based on a topology of the ONoC; and resetting nodes in the ONoC according to the self-healing strategy.

In some examples of the present disclosure, the identifying a failed node in the ONoC may include: obtaining status information of each node in the ONoC; and determining the failed node in the ONoC according to the status information.

In some examples of the present disclosure, the identifying a failed node in the ONoC may include: monitoring each node in the ONoC via a heartbeat mechanism; and designating a node failing to respond within a predetermined time period as the failed node in the ONoC.

In some examples of the present disclosure, the determining a self-healing strategy based on a topology of the ONoC may include: determining the topology of the ONoC; and generating a corresponding self-healing strategy for the ONoC according to the topology of the ONoC and the status information of each node in the ONoC.

In some examples of the present disclosure, generating a corresponding self-healing strategy for the ONoC according to the topology of the ONoC and the status information of each node in the ONoC may include: in response to determining that the topology of the ONoC is a ring topology, generating the self-healing strategy may include: for each backup node in the ONoC, calculating a proximity score for the backup node based on a distance between the failed node and the backup node, signal qualities of inter-node links, and a historical failure frequency of the backup node; determining a target backup node according to the proximity score of each backup node in the ONoC; and replacing the failed node with the target backup node to establish a transmission link.

In some examples of the present disclosure, the generating the self-healing strategy may further include: identifying a failed path based on the failed node; constructing a redundant path in an opposite direction to the failed path; and adjusting optical links via an optical switch matrix to enable a bidirectional transmission.

In some examples of the present disclosure, generating a corresponding self-healing strategy for the ONoC according to the topology of the ONoC and the status information of each node in the ONoC may include: in response to determining that the topology of the ONoC is a star topology, generating the self-healing strategy may include: identifying a shadow central node corresponding to the failed node in ONoC; and establishing transmission links between peripheral nodes of the failed node and the shadow central node.

In some examples of the present disclosure, the generating the self-healing strategy may further include: adjusting a micro-ring resonator of the shadow central node to differentiate an operating wavelength from that of the failed node.

In some examples of the present disclosure, the generating a corresponding self-healing strategy for the ONoC according to the topology of the ONoC and the status information of each node in the ONoC may include: in response to determining that the topology of the ONoC is a tree topology, generating the self-healing strategy may include: inputting the status information of child nodes of the failed node and a network load of the ONoC into a preset reinforcement learning model to obtain an alternative path corresponding to the failed node.

In some examples of the present disclosure, the self-healing strategy may further include: in response to determining an optical power loss of the alternative path exceeds a first predetermined threshold, searching for idle child nodes within a preset range to perform a supplementary node placement.

In some examples of the present disclosure, generating a corresponding self-healing strategy for the ONoC according to the topology of the ONoC and the status information of each node in the ONoC may include: in response to determining that the topology of the ONoC is a mesh topology or a torus topology, generating the self-healing strategy may include: inputting a node coordinate matrix of the ONoC, historical traffic data, and loads of links of the ONoC into a spatial temporal graph convolutional network (ST-GCN) to generate a predicted traffic map that indicates potential congestion areas in the ONoC; and deriving an alternative path based on the predicted traffic map.

In some examples of the present disclosure, the deriving an optimal alternative path based on the predicted traffic map may include: in response to determining a proportion of failed nodes is lower than a second predetermined threshold, calculating the alternative path according to the predicted traffic map; in response to determining the proportion of the failed nodes reaches or exceeds the second predetermined threshold, partitioning the ONoC into multiple sub-networks and reconfigure the multiple sub-networks into a tree topology network.

In some examples of the present disclosure, the self-healing strategy may further include: deploying nodes in the ONoC in a micro blockchain framework; electing a temporary master node within a vicinity of the failed node in the ONoC; and constructing temporary transmission links based on the temporary master node.

In some examples of the present disclosure, the resetting node interconnects of the ONoC according to the self-healing strategy may include: determining backup nodes in the ONoC based on the self-healing strategy; generating control instructions based on the self-healing strategy; sending the control instructions to the backup nodes; activating the backup nodes according to the control instructions; and updating a global routing table of the ONoC; where, the global routing table is used to store routing information of all nodes in the ONoC.

Based on the same inventive concept, the present disclosure further provides an electronic device comprising a memory, a processor, and a computer program stored on the memory and executable by the processor, wherein the processor executes the computer program to implement the method described above.

Based on the same inventive concept, the present disclosure further provides a non-transitory computer-readable storage medium storing computer instructions, wherein the computer instructions are used to cause a computer to execute the method described above.

It can be seen from the above description that the self-healing method and device for node failures in an ONoC provided in one or more examples of the present disclosure can monitor status of the nodes in the ONoC in real time to detect and respond to node failures quickly. The self-healing method and device for node failures in an ONoC can also generate self-healing strategies to reset links between the nodes in the ONoC. In this way, impacts of the node failures on an overall performance of the ONoC can be reduced greatly.

### BRIEF DESCRIPTION OF THE DRAWINGS

To illustrate technical solutions of the present disclosure or the prior art more clearly, drawings used in examples or the prior art will be briefly introduced. Obviously, the drawings in the following description are only some examples of the present disclosure. For those of ordinary skill in the art, other drawings may be obtained based on these drawings without creative effort.

FIG. 1 is a flowchart of a self-healing method for node failures in an ONoC according to an example of the present disclosure.

FIG. 2 is a structural diagram of a self-healing device for node failures in an ONoC according to an example of the present disclosure.

FIG. 3 illustrates the self-healing strategy corresponding to the ring topology described in according to an example of the present disclosure.

FIG. 4 illustrates an example of the self-healing strategy corresponding to the ring topology described in according to an example of the present disclosure.

FIG. 5 illustrates the self-healing strategy corresponding to the star topology described in according to an example of the present disclosure.

FIG. 6 illustrates an example of the self-healing strategy corresponding to the star topology described in according to an example of the present disclosure.

FIG. 7 illustrates the self-healing strategy corresponding to the tree topology described in according to an example of the present disclosure.

FIG. 8 is a hardware structure diagram of an electronic device according to an example of the present disclosure.

### DETAILED DESCRIPTION OF THE EMBODIMENTS

To make the objectives, technical solutions, and advantages of the present disclosure clearer, the following further describes the present disclosure in detail with reference to specific examples and accompanying drawings.

It should be noted that, unless otherwise defined, technical terms or scientific terms used in the examples of the present disclosure shall have the ordinary meanings understood by persons skilled in the art. The terms “first,” “second,” and similar terms used in the examples of the present disclosure do not denote any order, quantity, or importance, but are merely used to distinguish different components. The terms “comprising” or “including” and similar terms mean that elements or items preceding the term encompass elements or items listed after the term and their equivalents, but do not exclude other elements or items. The terms “connected” or “coupled” and similar terms are not limited to physical or mechanical connections, but may include electrical connections, whether direct or indirect. Terms such as “upper,” “lower,” “left,” and “right” are used only to indicate relative positional relationships. When the absolute position of the described object changes, the relative positional relationship may also change accordingly.

For clarity of the description, before describing specific technical solutions of the present disclosure, it is necessary to explain some terms involved in the present disclosure at first.

As mentioned above, current topology fault-tolerant technologies have great difficulties to meet stringent requirements on the high reliability and persistence in complex network environments. Therefore, there is a critical need to develop a self-healing method of network topology in an ONoC applicable in diverse topological structures, supporting rapid self-healing capabilities, and enabling effective dynamic response with adaptive reconfiguration facing node failures.

Examples of the present disclosure propose a self-healing method for node failures in an ONoC, which can achieve adaptive adjustments on topologies of the ONoC when a node failure occurs, enabling an ONoC have fast self-healing capabilities. To be noted, the self-healing method for node failures in an ONoC proposed can be adapted to different topologies.

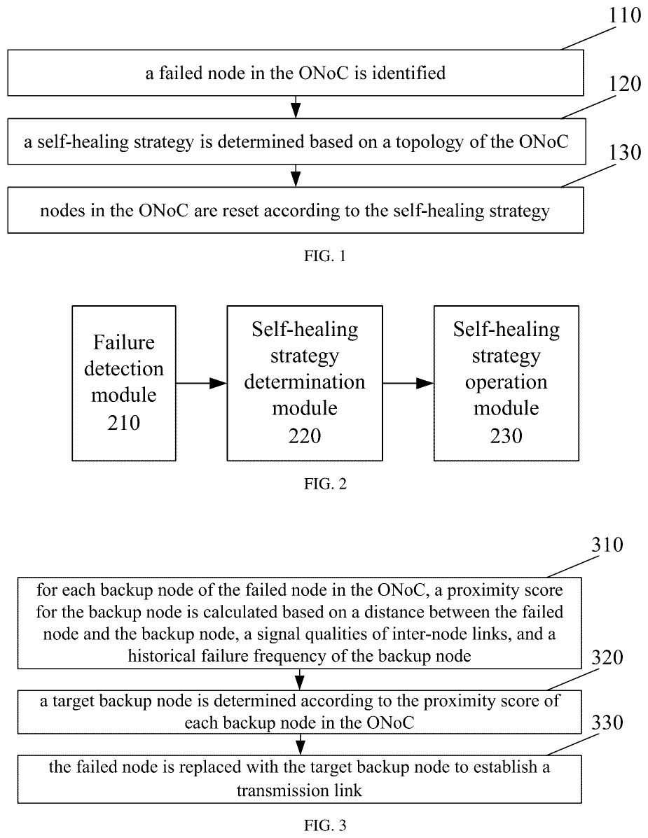

FIG. 1 is a flowchart of a self-healing method for node failures in an ONoC according to an example of the present disclosure. According to FIG. 1, the self-healing method for node failures in an ONoC may include the following steps.

In block 110, a failed node in the ONoC is identified.

In block 120, a self-healing strategy is determined based on a topology of the ONoC.

In block 130, nodes in the ONoC are reset according to the self-healing strategy.

In some examples of the present disclosure, the self-healing method for node failures in an ONoC described above can be applied to a self-healing device for node failures in an ONoC as shown in FIG. 2. In FIG. 2, the self-healing device for node failures in an ONoC may include: a failure detection module 210, a self-healing strategy determination module 220, and a self-healing strategy operation module 230. Where, the failure detection module 210 is configured to identify a failed node in the ONoC. The self-healing strategy determination module 220 is configured to determine a self-healing strategy based on a topology of the ONoC. Moreover, the self-healing strategy operation module 230 is configured to reset nodes in the ONoC according to the self-healing strategy.

It should be noted that the self-healing device for node failures in an ONoC can be applied to a communication architecture which includes the self-healing device itself, a signaling layer, and an optical network layer. The signaling layer may be controlled by the self-healing device for node failures in an ONoC. Moreover, the signaling layer may include: electrical router nodes and telecommunication channels. The optical network layer may include: business generation modules, optical router nodes, transmission waveguides, and electrical/optical (E/O) converters, as well as optical/electrical (O/E) converters.

Before implementing the method provided, the self-healing device for node failures in an ONoC should be initialized. During an initialization process, it is necessary to build a foundation for network operations.

Specifically, the initialization process of the self-healing device may include: creating a global routing table, planning paths for packet transmissions, and ensuring data flowing in the network in an order; initializing the failure detection module 210 to lay a solid foundation for real-time monitoring of status of nodes and detection of potential faults. At the same time, the signaling layer may be configured to have abilities to support efficient data transmissions and to ensure smooth interactions of network communication instructions.

In a topology design phase, it is necessary to ensure that the number of nodes is greater than the number of links in order to create a stable and reliable network infrastructure. Mature network topologies such as a star topology, a ring topology or a tree topology can be selected to meet requirements on the performance of different application scenarios.

In addition, initial parameters of an off chip controller can be set to enable precise communications with on-chip nodes, achieving internal and external collaborative controls. At the same time, a coordinate system may be constructed to allocate unique coordinates to each node accurately to anchor the position of each node in the network topology. In this way, a support of an efficient fault location may be obtained. Therefore, a comprehensive evaluation work may be performed, which may improve the efficiency of network management and maintenance greatly.

Detailed explanations of each step of the self-healing method for node failures in an ONoC will be provided with specific examples and accompanying drawings.

In block 110, according to examples of the present disclosure, the method of identifying a failed node in the ONoC may include: obtaining status information of each node in the ONoC; and determining the failed node in the ONoC according to the status information of each node in the ONoC.

In order to obtain the status information of each node in the ONoC, the self-healing device for node failures in the ONoC may further include a monitoring module. The monitoring module may utilize an off chip controller to monitor nodes in the ONoC to obtain the status information of each node in the ONoC. Specifically, the status information may include parameters such as a temperature, a transmission power, a transmission delay, a data packet loss rate, and a link quality.

The status information can be collected through sensors such as miniature light sensors, thermocouples, or electronic sensors. In addition, the monitoring module may adopt a full monitoring pattern or an incremental monitoring pattern. In addition, a real-time analysis of node behaviors can be conducted to identify potential abnormal fluctuations, therefore, data can be processed more efficiently.

In examples of the present disclosure, the monitoring module can monitor the nodes at preset times or upon instructions or signals received.

In examples of the present disclosure, the failure detection module 210 may identify node failures through preset fault detection algorithms based on the status information obtained by the monitoring module. It should be noted that, types of the fault detection algorithms would not be limited by the disclosure. In addition, when identifying a node failure, it is possible to further identify a type and a severity of the node failure. Where, the types of the node failure may include a power drop, a path interruption, a node loss and etc. The severity of the node failure can be evaluated based on whether the node is a critical node (such as a central node or a high load node) and what potential network impact it may cause. In addition, a specific location of the node failure can be further determined.

In other examples of the present disclosure, the failure detection module 210 may utilize an off chip controller to monitor nodes in the ONoC based on a heartbeat mechanism. A node that fails to respond within a predetermined period of time may be identified as a failed node in the ONoC. Specifically, based on the heartbeat mechanism, the off chip controller will send instructions periodically to every node in the ONoC. According to the heartbeat mechanism, a node that does not respond within the predetermined period of time may be regarded as malfunctioned, that is, the failed node.

In this disclosed embodiment, after determining a failed node in the ONoC, it can be further determined whether the failed node can be restored. When it is determined that the failed node cannot be restored, the block 120 may be executed to implement a self-healing operation on the ONoC. Meanwhile, it is also possible to repair the failed node.

With respect to the block 120, the self-healing strategy may be determined based on the topology of the ONoC when implementing the self-healing operation.

It was found in the process of implementing the disclosed example that each topology may have unique structural characteristics and node distribution patterns. For example, nodes with the ring topology may be connected in a ring shape. Nodes with the star topology may have a central node and other nodes may be distributed around the central node. Nodes with the tree topology may have a multi-level distribution with a hierarchical structure. Nodes with the mesh topology or the torus topology may be distributed in a mesh form without redundant nodes. Therefore, adaptive self-healing strategies may be implemented based on different topologies, and the efficiency of self-healing may be improved effectively.

Specifically, different self-healing strategies of different topologies would be described in detail below.

With regard to the ring topology, one or more backup nodes may be set for each node of the ring topology in the ONoC.

According to some examples of the present disclosure, a self-healing strategy corresponding to the ring topology may include a process shown in FIG. 3. Moreover, during the network reset procedure, nodes and links between the nodes in the ONoC may be reset according to the self-healing strategy shown in FIG. 3. As shown in FIG. 3, the self-healing strategy corresponding to the ring topology may include the following steps.

In block 310, for each backup node of the failed node in the ONoC, a proximity score for the backup node is calculated based on a distance between the failed node and the backup node, a signal qualities of inter-node links, and a historical failure frequency of the backup node.

In examples of the present disclosure, in order to achieve a self-healing of a failed node, it is necessary to pre-set one or more backup nodes for each node in the ring topology within a vicinity of the node.

In examples of the present disclosure, the proximity score may be obtained based on a distance between the failed node and the backup node, signal qualities of inter-node links, and a historical failure frequency of the backup node in the ONoC. In some examples, the proximity score may be determined by the following expression:

$$S = α \cdot \frac{1}{d} + β \cdot SNR + γ \cdot ( 1 - {F}_{history} )$$

Where, α, β, and γ may preset weight coefficients. In some examples, α, β, and γ may be set to 0.5, 0.3 and 0.2, respectively. d may represent the distance between the failed node and the backup node. SNR may represent the signal qualities of inter-node links. F_{history} may represent the historical failure frequency of the backup node.

In block 320, a target backup node is determined according to the proximity score of each backup node in the ONoC.

In block 330, the failed node is replaced with the target backup node to establish a transmission link.

With regard to the block 320, a backup node with a highest proximity score can be determined as the target backup node to generate a new transmission link.

In the above method, in order to ensure that the occurrence of a failed node does not affect data transmission before a new transmission link is generated, the self-healing strategy may further include the following steps.

First, a failed path is identified based on the failed node.

In example of the present disclosure, after determining the failed node, the data transmission link containing the failed node can be taken as the failed path.

Then, a redundant path is constructed in an opposite direction to the failed path.

In example of the present disclosure, parameters of micro-ring resonators (MRR) of all optical routers in the ONoC can be adjusted to construct the redundant path with the opposite direction to the failed path, which serves as a physical basis for optical link adjustment.

Specifically, in case that the failed path is in a direction of counterclockwise, the resonant wavelength of the MRRs in optical routers of the ONoC can be activated to construct a clockwise redundant path.

Further, optical links are adjusted via an optical switch matrix to enable a bidirectional transmission.

In this block, bidirectional path transmissions can be enabled through an Optical Switch Matrix (OSM) to ensure a multi-path load balancing and reduce the impact of the failed node. In this step, real-time business and disaster recovery data can also be distinguished by priority tags to avoid congestions.

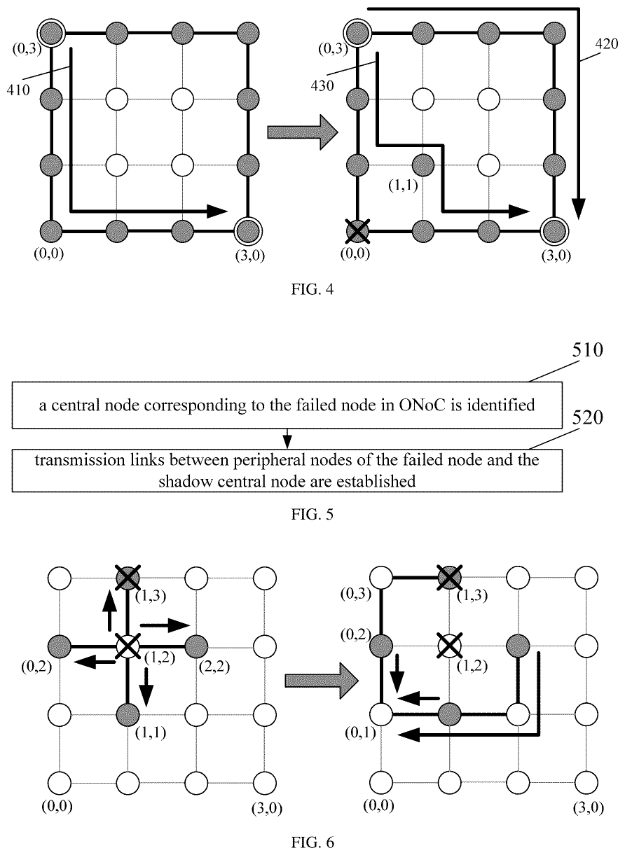

FIG. 4 illustrates an example of the self-healing strategy corresponding to the ring topology described in according to an example of the present disclosure. In the example shown in FIG. 4, under normal conditions, data packets will be transmitted through a counterclockwise path in a ring topology. For example, for a data packet sent from node (0,3) to node (3,0), the transmission path of the data packet may include node (0,3), node (0,2), node (0,1), node (0,0), node (1,0), node (2,0), and node (3,0) (the path labeled 410 in FIG. 4). In this case, when node (0,0) fails, a clockwise path (marked as 420 in FIG. 4) can be established first to form a loop with the original transmission path. Then, the proximity scores of each backup node of the faulty node (0,0) may be further determined, and the backup node with the highest proximity score may be determined as the target backup node. For example, node (1,1) is determined as the target backup node, and based on the determined target backup node (1,1), the failed node (0,0) in the ONoC may be replaced to construct a new transmission path (labeled 430 in FIG. 4).

From this, it can be seen that through the above method, the topology of the ONoC can be adjusted adaptively in the event of a node failure in a ring topology.

With regard to the star topology, in the ONoC, a main center node and a corresponding shadow center node, as well as peripheral nodes other than the main center node may be preset. In this example, a technical solution is proposed for the situation where the main central node of the star topology in the ONoC fails.

In some examples of the present disclosure, a self-healing strategy corresponding to the star topology may include a process shown in FIG. 5. Moreover, during the network reset procedure, nodes and links between the nodes in the ONoC can be reset according to the self-healing strategy shown in FIG. 5. As shown in FIG. 5, the self-healing strategy corresponding to the ring topology may include the following steps.

In block 510, a shadow central node corresponding to the failed node in ONoC is identified.

In block 520, transmission links between peripheral nodes of the failed node and the shadow central node are established.

In some examples of the present disclosure, to avoid channel conflicts between the shadow center node and the main center node, the wavelength of the micro-ring resonator of the shadow center node can be adjusted to differentiate its wavelength from that of the failed node. Therefore, data packets can be transmitted seamlessly based on the new wavelength.

In some examples, dedicated optical channels may be reserved for high priority services based on service priorities.

FIG. 6 illustrates an example of the self-healing strategy corresponding to the star topology described in according to an example of the present disclosure. As shown in FIG. 6, the main central node of the star topology is node (1,2), and its corresponding shadow central node is node (0,1). When the main central node (1,2) fails, for the peripheral nodes of the original links, such as nodes (0,2), (1,1), and (2,2), backup transmission links between each of the peripheral nodes and the shadow central node will be reconstructed. Where, node (0,2) and node (1,1) can be connected to the shadow center node (0,1) directly. However, node (2,2) will be connected to the shadow center node (0,1) through node (2,1) and node (1,1).

From this, it can be seen that through the above method, the topology of the ONoC can be adjusted adaptively in the event of a node failure in the star topology.

For a tree topology, backup child nodes of a parent node can be pre-stored, and the status information of the backup child nodes (such as a bandwidth, a latency, and a packet loss rate) can be updated in real-time and cached locally.

In some examples of the present disclosure, a self-healing strategy corresponding to the tree topology may include a process below. Moreover, during the network reset procedure, nodes and links in the ONoC can be reset according to the self-healing strategy below. The self-healing strategy corresponding to the tree topology may include the following steps: inputting the status information of child nodes of the failed node in the ONoC and a load of the ONoC into a preset reinforcement learning model to obtain an alternative path corresponding to the failed node.

In examples of the present disclosure, the status information of the child nodes and the load of the ONoC can be input into the preset reinforcement learning model to obtain the alternative path. Specifically, the preset reinforcement learning model may be established based on the Proximal Policy Optimization (PPO) algorithm.

In order to further improve the technical effect, examples of the present disclosure may also integrate an optical power monitoring module on the chip to detect a real-time optical signal strength of the reconstructed link. In response to determining an optical power loss of the alternative path exceeds a first preset threshold, idle child nodes within a preset range are searched for to perform a supplementary node placement. That is, when the optical power loss of the alternative path exceeds the first preset threshold, a local re-routing mechanism may be triggered to prioritize a selection of redundant idle child nodes for compensation in a nearby range, and re-evaluate a strength of optical signals of the links.

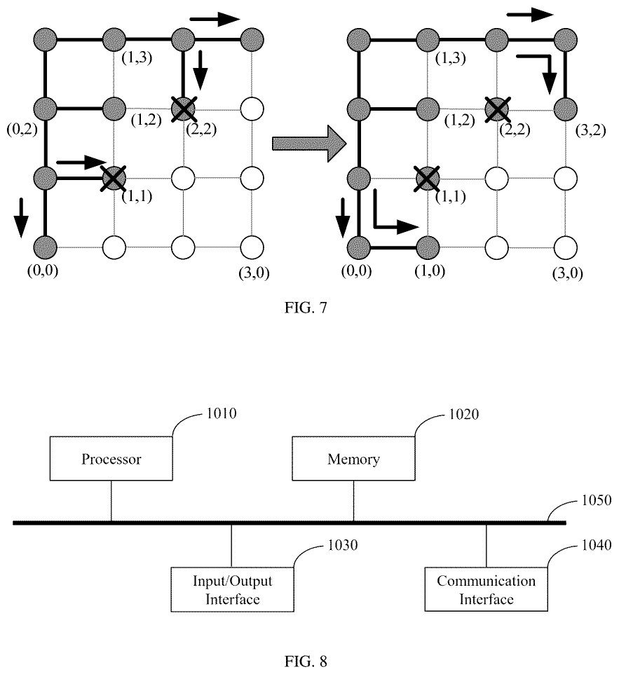

FIG. 7 illustrates the self-healing strategy corresponding to the tree topology described in according to an example of the present disclosure. As shown in FIG. 7, when the child node (1,1) and the child node (2,2) fail, the PPO reinforcement learning model may find node (1,0) and node (3,2) as alternative child nodes.

With respect to the mesh topology and the torus topology, a self-healing strategy of the predictive traffic engineering and the elastic topology transformation may be adopted. The self-healing strategy corresponding to the mesh topology and the torus topology may include the following steps: first, inputting a node coordinate matrix of the ONoC, historical traffic data, and the load of the ONoC into an ST-GCN to generate a predicted traffic map that indicates potential congestion areas in the ONoC; and then deriving an alternative path based on the predicted traffic map.

Specifically, nodes of the mesh topology or the torus topology can be embedded into micro blockchain modules and broadcast their own status information periodically (such as load, available links, failed indexes). When any node fails, the Raft consensus algorithm may be used to elect a temporary master node near the failed node. After determining the temporary master node, adjacent nodes may submit link resources to the temporary master node to construct temporary transmission links based on the temporary master node.

In examples of the present disclosure, in order to further improve the technical effect, the ST-GCN may be used for predicting potential congested areas. The input of the ST-GCN may include the node coordinate matrix, historical traffic data, and real-time loads of the links in the ONoC. The output of the ST-GCN may include a predicted traffic map that identifies potential congestion areas.

Further, an alternative path may be derived based on the predicted traffic map according to an improved ant colony algorithm. The alternative path refers to a path that bypasses the failed node. To be noted, an object of the improved ant colony algorithm can be set as minimizing both an end-to-end delay and a load imbalance. For example, the objective function of the improved ant colony algorithm may be set as:

$$Minimize {\sum }_{i = 1}^{N} ( \frac{{D}_{i}}{{D}_{max}} ) + λ \cdot {\sum }_{j = 1}^{M} {( \frac{{L}_{j} - \overline{L}}{L} )}^{2}$$

Where, λ represents a balance coefficient, which can be set to 0.6; L represents a total number of links; Lⱼ represents a load of the j^{th} link; L̅ represents an average load of the links; Dᵢ represents an end-to-end delay of the i^{th} path; and Dₘₐₓ represents a maximum allowable delay, which can be set to Dₘₐₓ=50 μs.

To further improve the technical effect, a topology adjustment strategy based on a density of the failed nodes can be implemented in a fuzzy logic controller. Specifically, in response to determining that a proportion of the failed nodes is less than a second predetermined threshold, the alternative path can be obtained based on the predicted traffic map. The improved ant colony algorithm sets the objective function to minimize both the end-to-end delay and the load imbalance. In response to determining that the proportion of the failed nodes is greater than or equal to the second predetermined threshold, the ONoC may be divided into multiple sub-networks and transformed into a tree topology structure, and sub-domain interconnection may be achieved through the top parent node optical router.

That is to say, the input of the fuzzy logic controller is the proportion, the location, and a business type weight of the failed nodes, and the output is the sub-network topology dynamically adjusted based on the location of the failed nodes and the business type weight of the failed nodes. In computationally intensive scenarios, it prioritizes reducing hops and improving throughput.

In the above block 130, after the self-healing strategy is determined, the self-healing operation module 230 may determine backup nodes in the ONoC based on the self-healing strategy, generate control instructions based on the self-healing strategy, send the control instructions to the backup nodes, activate the backup nodes according to the control instructions; and update a global routing table of the ONoC; where, the global routing table is used to store routing information of all nodes in the ONoC. Specifically, the self-healing operation module 230 may send a control signal to the backup nodes marked at the time of topology self-healing. After the optical router receives the control signal, the resonant wavelength of the micro-ring resonator may be adjusted to conduct or close the corresponding optical links, so as to ensure that the backup nodes takeover the link in a shortest time, and achieve a seamless switching of the communication function of the data packets. In addition, to avoid optical signal interference or transmission errors caused by parameter adjustments, the system needs to perform multiple state verifications after the adjustment is completed to ensure that the backup node fully has the replacement function, and then return an ACK message to the off chip controller.

After receiving the ACK message of successful link building from the backup node, the off chip controller may update the node path information stored in the global routing table to reflect the changes in the topology structure, and runs the shortest path optimization algorithm to recalculate the routing for all nodes in the network, ensuring that the data packets can be transmitted smoothly according to the self-healing topology. The signal layer is used to broadcast the routing table information to relevant nodes, and the broadcast adopts a layered design, prioritizing the synchronization of key nodes (central nodes and high traffic nodes) to minimize the risk of network interruption.

After a self-healing is completed, the self-healing device will verify a current status of the ONoC. By comparing an average delay, a throughput, an error rate, and link utilization parameters of the data packet transmission before and after self-healing, the network recovery will be evaluated. If the ratio of a same coefficient is found to be less than a third preset threshold, it would be determined that an abnormality occurs in the link. The self-healing strategy would be performed again. If the ratio is greater than the third preset threshold, it means there is no abnormality and nodes in the ONoC would be further monitored.

Therefore, the disclosed technical solution may adjust the self-healing strategy adaptively according to the topology of the ONoC. Under different topologies, the self-healing strategy will be optimized to minimize the cost of node reconfigurations and link reconstructions. In this way, the delay caused by link switching will be reduced, while ensuring the efficiency and continuity of data transmissions, to achieve a seamless activation of the backup nodes.

In summary, in examples of the present disclosure, with respect to the ring topology, when the off chip controller detects a node failure, the self-healing device may perform the following operations: adjusts the resonant wavelength of the micro-ring resonator (MRR), constructs a clockwise redundant loop, activates adjacent backup nodes, selects the target backup node based on a comprehensive scoring model of an Euclidean distance, link qualities, and a historical failure rate, adjusts an optical link connection using the optical switch matrix (OSM), enables a bidirectional path, and distinguishes real-time business and disaster recovery data through priority labels.

With respect to the star topology, when the central node fails, a backup switching may be achieved through the main shadow dual central node architecture. Specifically, a shadow node may take over control within 10 μs, adjust a wavelength of the micro-ring resonator to avoid channel conflicts, and reserve dedicated optical channels for high priority services.

With respect to the tree topology, when a parent node fails, the self-healing device may perform the following operations: using a PPO reinforcement learning model to generate the alternative path based on the status information of the child nodes and a real-time load of the ONoC. Moreover, a local re-routing mechanism may be triggered when an optical power attenuation exceeds a preset threshold.

With respect to the mesh topology or the torus topology, the self-healing device may perform the following operations: deploying a lightweight blockchain framework, electing a temporary master node, predicting a future traffic distribution using an ST-GCN when a failure occurs, generating the alternative path around the failure node through an improved ant colony algorithm (ACO), and updating only the local routing table. When the proportion of the failure nodes exceeds a preset threshold, the network is divided into multiple autonomous subdomains. The subdomains may be transformed into a tree topology and interconnected through the top parent node optical router. The fuzzy logic controller may adjust the generated subnet topology dynamically based on the relevant information of the failure nodes, optimizes the network structure according to the fault density and business type, and reduces the number of hops.

The disclosed technical solution may monitor the status information of each node in the ONoC. When a node failure occurs, a self-healing strategy may be selected based on the topology of the ONoC. Since a different self-healing strategy may be adopted for a different topology, seamless transmission of data packets may be ensured, and the reliability and the flexibility of the ONoC may be improved.

It should be noted that the methods of one or more examples disclosed herein can be executed by a single device, such as a computer or server. The method disclosed can also be applied to distributed scenarios, where multiple devices cooperate with each other to complete the task. In this distributed scenario, one device among these multiple devices can only perform one or more steps of the method disclosed in one or more embodiments, and these multiple devices will interact with each other to complete the method.

Based on a same inventive concept and corresponding to examples of the present disclosure, the present disclosure also provides an electronic device comprising: a memory, a processor, and a computer program stored on the memory and executable on the processor. When the processor executes the computer program, it implements the self-healing method for node failures in an ONoC disclosed.

FIG. 8 illustrates a more detailed hardware structure diagram of an electronic device according to this example. The device may include: a processor 1010, a memory 1020, an input/output interface 1030, a communication interface 1040, and a bus 1050. The processor 1010, memory 1020, input/output interface 1030, and communication interface 1040 are communicatively connected within the device via the bus 1050.

The processor 1010 may be implemented using a general-purpose CPU (Central Processing Unit), microprocessor, ASIC (Application-Specific Integrated Circuit), or one or more integrated circuits. It is configured to execute related programs to implement the technical solutions provided in the examples of the present specification.

The memory 1020 may be implemented using ROM (Read-Only Memory), RAM (Random Access Memory), static storage devices, or dynamic storage devices. The memory 1020 stores operating systems and other applications. When implementing the technical solutions of the examples of the present specification via software or firmware, related program codes are stored in the memory 1020 and invoked by the processor 1010 for execution.

The input/output interface 1030 is connected to an input/output module to enable information input and output. The input/output module may be integrated into the device (not shown) or externally connected to provide corresponding functions. Input devices may include keyboards, mice, touchscreens, microphones, and various sensors. Output devices may include displays, speakers, vibrators, and indicator lights.

The communication interface 1040 is connected to a communication module (not shown) to enable communication between the device and other devices. The communication module may use wired methods (e.g., USB, network cables) or wireless methods (e.g., mobile networks, Wi-Fi, Bluetooth).

The bus 1050 provides a pathway for transmitting information among components (e.g., processor 1010, memory 1020, input/output interface 1030, and communication interface 1040) of the device.

It should be noted that although the above device illustrates only the processor 1010, memory 1020, input/output interface 1030, communication interface 1040, and bus 1050, additional components necessary for normal operation may be included in practical implementations. Furthermore, those skilled in the art will understand that the device may include only components necessary for implementing the solutions of the examples of the present specification and need not include all components shown in the figure.

The electronic device in the above examples is used to implement the corresponding self-healing method for node failures in an ONoC in any of the preceding examples and has the beneficial effects of the corresponding method, which are not repeated here.

Based on the same inventive concept and corresponding to any of the above method, the present disclosure further provides a non-transitory computer-readable storage medium storing computer instructions. The computer instructions are configured to cause a computer to execute the self-healing method for node failures in an ONoC as described in any of the preceding examples.

The computer-readable medium in this example includes permanent and non-permanent, removable and non-removable media implemented by any method or technology for information storage. The information may be computer-readable instructions, data structures, program modules, or other data. Examples of computer storage media include, but are not limited to: phase-change memory (PRAM), static random-access memory (SRAM), dynamic random-access memory (DRAM), other types of RAM, read-only memory (ROM), electrically erasable programmable read-only memory (EEPROM), flash memory, other memory technologies, CD-ROM, DVD, other optical storage, magnetic cassettes, magnetic tape storage, other magnetic storage devices, or any other non-transitory media capable of storing information accessible to computing devices.

The storage medium in the above examples stores computer instructions for causing a computer to execute the self-healing method for node failures in an ONoC as described in any of the preceding examples, with the beneficial effects of the corresponding method, which are not repeated here.

Those skilled in the art should understand that the discussion of the above examples is exemplary and not intended to imply that the scope of the present disclosure (including the claims) is limited to these examples. Under the principles of the present disclosure, the technical features in the above examples or different examples may be combined, steps may be executed in any order, and many other variations exist as described in the different aspects of the examples of the present disclosure, which are not detailed for brevity.

Additionally, to simplify explanation and discussion and to avoid obscuring the examples of the present disclosure, known power/ground connections to integrated circuit (IC) chips and other components may or may not be shown in the provided figures. Furthermore, devices may be illustrated in block diagram form to avoid obscuring the examples, considering that implementation details of such block diagrams are highly platform-dependent (i.e., these details should be fully understandable to those skilled in the art). When specific details (e.g., circuits) are provided to describe exemplary examples of the present disclosure, it will be apparent to those skilled in the art that the examples may be practiced without these details or with modifications thereto. Thus, the descriptions are to be regarded as illustrative rather than restrictive.

Although the present disclosure has been described with reference to specific examples, many alternatives, modifications, and variations will be apparent to those skilled in the art based on the foregoing description. For example, other memory architectures (e.g., dynamic RAM (DRAM)) may be used in the discussed examples.

The examples of the present disclosure are intended to cover all such alternatives, modifications, and variations falling within the broad scope of the appended claims. Therefore, any omissions, modifications, equivalent substitutions, or improvements made within the spirit and principles of the examples of the present disclosure shall be included within the scope of protection of the present disclosure.

What is claimed is:

1. A self-healing method for node failures in an Optical Network-on-Chip (ONoC), comprising:
identifying a failed node in the ONoC;
determining a self-healing strategy based on a topology of the ONoC; and
resetting nodes in the ONoC according to the self-healing strategy.

2. The method according to claim 1, wherein, the identifying a failed node in the ONoC comprises:
obtaining status information of each node in the ONoC; and
determining the failed node in the ONoC according to the status information.

3. The method according to claim 1, wherein, the identifying a failed node in the ONoC comprises:
monitoring each node in the ONoC via a heartbeat mechanism; and
designating a node failing to respond within a predetermined period of time as the failed node in the ONoC.

4. The method according to claim 1, wherein, the determining a self-healing strategy based on a topology of the ONoC comprises:
determining the topology of the ONoC; and
generating a corresponding self-healing strategy for the ONoC according to the topology of the ONoC and status information of each node in the ONoC.

5. The method according to claim 4, wherein, the generating a corresponding self-healing strategy for the ONoC according to the topology of the ONoC and status information of each node in the ONoC comprises:
in response to determining that the topology of the ONoC is a ring topology,
for each backup node in the ONoC, calculating a proximity score for the backup node based on a distance between the failed node and the backup node, signal qualities of inter-node links, and a historical failure frequency of the backup node;
determining a target backup node according to the proximity score of each backup node in the ONoC; and
replacing the failed node with the target backup node to establish a transmission link.

6. The method according to claim 5, wherein, the generating a corresponding self-healing strategy for the ONoC according to the topology of the ONoC and status information of each node in the ONoC further comprises:
identifying a failed path based on the failed node;
constructing a redundant path in an opposite direction to the failed path; and
adjusting optical links via an optical switch matrix to enable a bidirectional transmission.

7. The method according to claim 4, wherein, the generating a corresponding self-healing strategy for the ONoC according to the topology of the ONoC and status information of each node in the ONoC comprises:
in response to determining that the topology of the ONoC is a star topology,
identifying a shadow central node corresponding to the failed node in ONoC; and
establishing transmission links between peripheral nodes of the failed node and the shadow central node.

8. The method according to claim 7, wherein, the generating a corresponding self-healing strategy for the ONoC according to the topology of the ONoC and status information of each node in the ONoC further comprises:
adjusting a micro-ring resonator of the shadow central node to differentiate an operating wavelength from that of the failed node.

9. The method according to claim 4, wherein, the generating a corresponding self-healing strategy for the ONoC according to the topology of the ONoC and status information of each node in the ONoC comprises:
in response to determining that the topology of the ONoC is a tree topology, inputting the status information of each child node of the failed node and a network load of the ONoC into a preset reinforcement learning model to obtain an alternative path corresponding to the failed node.

10. The method according to claim 9, wherein, the generating a corresponding self-healing strategy for the ONoC according to the topology of the ONoC and status information of each node in the ONoC further comprises:
in response to determining an optical power loss of the alternative path exceeds a first predetermined threshold, searching for idle child nodes within a preset range to perform a supplementary node placement.

11. The method according to claim 4, wherein, the generating a corresponding self-healing strategy for the ONoC according to the topology of the ONoC and status information of each node in the ONoC comprises:
in response to determining that the topology of the ONoC is a mesh topology or a torus topology,
inputting a node coordinate matrix of the ONoC, historical traffic data, and loads of links of the ONoC into a spatial temporal graph convolutional network to generate a predicted traffic map that indicates potential congestion areas in the ONoC; and
deriving an alternative path based on the predicted traffic map.

12. The method according to claim 11, wherein, the deriving an alternative path based on the predicted traffic map comprises:
in response to determining a proportion of failed nodes is lower than a second predetermined threshold, calculating the alternative path according to the predicted traffic map; and
in response to determining the proportion of the failed nodes reaches or exceeds the second predetermined threshold, partitioning the ONoC into multiple sub-networks and reconfigure the multiple sub-networks into a tree topology network.

13. The method according to claim 11, wherein, the generating a corresponding self-healing strategy for the ONoC according to the topology of the ONoC and status information of each node in the ONoC further comprises:
deploying nodes in the ONoC in a micro blockchain framework;
electing a temporary master node within a vicinity of the failed node in the ONoC; and
constructing temporary transmission links based on the temporary master node.

14. The method according to claim 1, wherein, the resetting nodes in the ONoC according to the self-healing strategy comprises:
determining backup nodes in the ONoC based on the self-healing strategy;
generating control instructions based on the self-healing strategy;
sending the control instructions to the backup nodes;
activating the backup nodes according to the control instructions; and
updating a global routing table of the ONoC; where, the global routing table is used to store routing information of all nodes in the ONoC.

15. An electronic device, comprising: a memory, a processor, and a computer program stored on the memory and executable by the processor, wherein, the processor executes the computer program to implement the method according to claim 1.

16. A non-transitory computer-readable storage medium, comprising: computer instructions, wherein, the computer instructions are used to cause a computer to execute the method according to claim 1.
